(19) United States
(12) Patent Application Publication
(10) Pub. No.: US 2021/0096535 A1
(43) Pub. Date: Apr. 1, 2021

(54) Multi-tool fabrication machine

(71) Applicant: John Theodore Wigand, Nashua, NH (US)

(72) Inventor: John Theodore Wigand, Nashua, NH (US)

(21) Appl. No.: 16/585,000

(22) Filed: Sep. 27, 2019

(51) Int. Cl. G05B 19/4097

(52) U.S. Cl. CPC G05B 19/4097; G05B 2219/35134; G05B 2219/45041; G05B 2219/45145; G05B 2219/45212; G05B 2219/50291

(57) ABSTRACT

A self-configuring computer-controlled fabrication apparatus that utilizes no fewer than four user changeable tools concurrently installed to fabricate a three-dimensional component from digital design data out of a variety of materials using additive and/or subtractive methods. User interchangeable tools perform different tasks including paste extrusion, filament extrusion, inkjet deposition, laser curing, laser etching, milling, cooling, curing, inspection, and component placement, among others. Each tool, that is selected and installed by the user for each job, contains operational information regarding its performance in nonvolatile memory such that the system can read, then adapt, the build process to the set of tools currently installed.

### BACKGROUND ART

| | | |
|---|---|---|
| 10,073,434 | Hollander | Manufacturing systems and methods with multiple |
| | | independent tool heads |
| 8,827,684 | Schumacher, et | 3D printer and printhead unit with multiple |
| | al. | filaments |
| 10,065,241 | Dods | Combined additive manufacturing and machining |
| | | system |
| 10,034,964 | Bonassar, et al. | Modular fabrication systems and methods |
| 9,919,474 | Napadensky | Solid freeform fabrication using a plurality of |
| | | modeling materials |
| 7,625,198 | Lipson, et al. | Modular fabrication systems and methods |
| 9,908,290 | Clayton | Configurable printers |
| 20160067920 | Fontaine | Modular user-configurable multi-part 3D layering |
| | | system and hot end assembly |

### Novelty of this Invention Relative to Background Art

U.S. Pat. No. 10,073,434—Hollander
The Hollander patent specifically claims two independent tools that are mounted on a rotational axis.
This application uses at least four tools that are mounted on independent z-axis linear actuators.

U.S. Pat. No. 8,827,684—Schumacher, et al.
The Schumacher patent specifically claims a fixed extrusion module.
This application does not use any fixed extrusion modules. All tools (extruders) are mounted on a carriage that moves in the Y and Z directions.

U.S. Pat. No. 10,065,241—Dods
The Dods patent specifically claims that a cryogenic fluid source be in contact with the machining tool.
This application does not use any cryogenic fluids.

U.S. Pat. No. 10,034,964—Bonassar, et al.
The Bonassar patent specifically claims the use of 94.+−5% viable living cells as the print material.
This application uses other materials beyond living cells.

U.S. Pat. No. 9,919,474—Napadensky
The Napadensky patent specifically claims a method.
This application is for an apparatus.

U.S. Pat. No.

7,625,198—Lipson, et al.
The Lipson patent specifically claims only the use of deposition tools and is not self-configuring.
This application is for an apparatus that uses a broader range of tools including subtractive (among others) and is self-configuring.

U.S. Pat. No. 9,908,290—Clayton
The Clayton patent specifically claims the use of a secondary motion system and only two heads.
This application is for an apparatus with a singular motion system and a minimum of four heads (tools).

20160067920—Fontaine
The Fontaine application specifically claims user-predetermined spacings between deposition heads.
This application has a fixed distance (spacing) between deposition heads (tools).

### SUMMARY OF INVENTION

Components for industrial, commercial, and consumer use are commonly formed by at least one of three basic fabrication methods: formation, subtractive, or additive. Formation fabrication is the process of creating a mold, typically in the shape of a “negative” of the desired component, then filling that mold with material in a liquid form such that it takes the shape of the mold before solidifying. The mold is removed and solid material in the shape of the component remains. Subtractive fabrication is the process of starting with an excess of material in solid form and cutting away the material that is not wanted to expose the component within. Additive fabrication is a process in which a three-dimensional digital description of an object is cross-sectioned into a series of thin layers. Each layer is then printed on top of each other using a computer-controlled motion system. ISO/ASTM-2900-15 defines seven basic processes for additive manufacturing. This invention is a machine that utilizes all three fabrication methods, allowing customers to leverage and combine each method as they see appropriate for the component they wish to build.

The basic machine consists of electronics that control the XYZ position of multiple tool tips relative to a build surface. The novel aspect of this machine is that the tools provide a variety of different functions and can easily be changed and/or combined by the user. As different tools are removed and attached to the machine, the machine reads data off the tool to understand that tool's capabilities and configures itself for use with respect to those capabilities along with the capabilities of all the other tools currently attached as well.

Tools may include, but not be limited to: milling cutter, laser etching, laser curing, filament fused deposition, paste extrusion deposition, droplet printing, visual inspection, distance scanning, touch probe, vacuum, and heated probe, among others. This machine embodies no fewer than four tool slots allowing any combination of tools to be used, providing upwards of 5,000 possible tool combinations to be created. This creates the obvious advantage of a highly versatile fabrication machine capable of producing a wide variety of components out of a wide variety of materials.

There are several advantages to a machine having at least four active tool slots. When configured to use four additive fabrication tools the ability to deposit four different materials becomes possible. This is not particularly unique if all four additive tools function in the same manner (as filament fused deposition modeling devices would use four colors for example). What is unique is that the additive tools do not have to utilize the same process. One tool may deposit hard plastic via filament fused deposition modelling (melting filament then extruding out a nozzle after which it re-freezes) while another tool may deposit soft silicone via paste extrusion deposition modelling (squeezing liquid paste out of syringe) while a third tool may deposit photo-cured conductive ink via droplet deposition and yet a fourth tool may provide the UV light to cure the photo-cured conductive ink. The resulting component would be a flex-circuit that has hard plastic ends for mating with other connections and a flexible silicone insulation incasing electrically conductive traces.

In another embodiment, maybe only three additive tools are used and one subtractive tool is used. In this case the user may use an additive filament fused deposition tool to print a plastic frame, a milling cutter tool to enhance the surface finish of the plastic that was just deposited, an additive paste extrusion deposition tool to print soft silicone gaskets onto the plastic frame, and a final additive paste extrusion deposition tool to deposit a removable support structure. The resulting component would be a hard plastic lid with a soft gasket for making an air tight seal.

In yet another embodiment, maybe three additive tools and one laser tracing tool is used. In this case the user may use an additive extrusion deposition tool to deposit a powder binder paste that is electrically conductive, another additive extrusion deposition tool to deposit a powder binder paste that is dielectric, a third additive extrusion deposition tool to deposit a removable support structure, and a fourth tool that uses a laser beam to trace over the materials previously deposited by the extrusion tools to remove (vaporize) the binder and fuse the powder together on a layer-by-layer basis. The resulting component would be a rigid high power electronic circuit capable of carrying high current.

In yet another embodiment, maybe three additive tools and one flame burner tool is used. In this case the user may use an additive paste extrusion deposition tool to deposit cake batter, another paste extrusion deposition tool to deposit raspberry filling, another paste extrusion deposition tool to deposit chocolate frosting, and the flame burner tool to “bake” the deposited cake batter in a layer by layer fashion before the filling and chocolate are deposited. The resulting component would be dessert.

It is not practical to list all the combinations or uses that are possible with this machine attesting to the novelty of such a machine. The wide range of material and tool combinations would not be possible without the ability for the machine to self-configure. Each tool contains a non-volatile memory that includes information about the tool and its usage. When plugged into the machine, the machine reads that memory to understand how that tool can be used for fabrication. Software within the machine then combines that tool's functions with the functions of the other tools that are installed to generate a set of possible fabrication processes available with that set of tools. The most common process for that configuration is selected as the default, but the other possible processes are presented to the user. The user is able to select which process to be used under that configuration with very little limitation.

### BRIEF DESCRIPTION OF DRAWINGS

FIG. 1—Multi-tool fabrication machine without any tools installed. The fabrication apparatus 1 consists of an electronics cabinet 2 that contains such items as a power supply, computer, and relays. The electronics cabinet 2 coordinates the movement of the X-Axis 3, Y-Axis 4, and Z-Axis 5. The coordinated motion of the three axes provide controlled relative positioning of the build platform 6 to the tool carriage 7.

FIG. 2—The multi-tool fabrication machine with tools installed. The tool carriage 7 contains four slots in which individual tools of any type can be installed. In this example, two extrusion tools 8 that are capable of depositing materials in paste format are installed on the rear two slots of the tool carriage 7. A laser tool 9 and an FDM tool 18 are installed in the front two slots.

FIG. 3—The extrusion tool. The extrusion tool 8 is an additive paste extrusion tool that can be plugged into the tool carriage 7 by the user. The extrusion tool 8 is used to deposit materials in paste form that are subsequently cured by exposure to air, or by other means such as heat.

FIG. 4—The laser tool. The laser tool 9 is a subtractive or curing tool that can be plugged into the tool carriage 7 by the user. The laser tool 9 is used to either etch target material with text (e.g. part numbers, etc.) or a surface finish. It may also be used to cure target material with heat (e.g. epoxy, cake batter, etc.).

FIG. 5—The FDM tool. The FDM tool 18 is an additive plastic filament extrusion tool that can be plugged into the tool carriage 7 by the user. The FDM tool 18 is used to deposit a variety of plastics.

FIG. 6—The milling cutter tool. The milling cutter tool 22 is a subtractive cutting tool that can be plugged into the tool carriage 7 by the user. The milling cutter tool 22 is used to trim previously deposited surfaces to improve surface finish, or to mill away material in a manner similar to a CNC milling machine.

### APPARATUS DETAILS

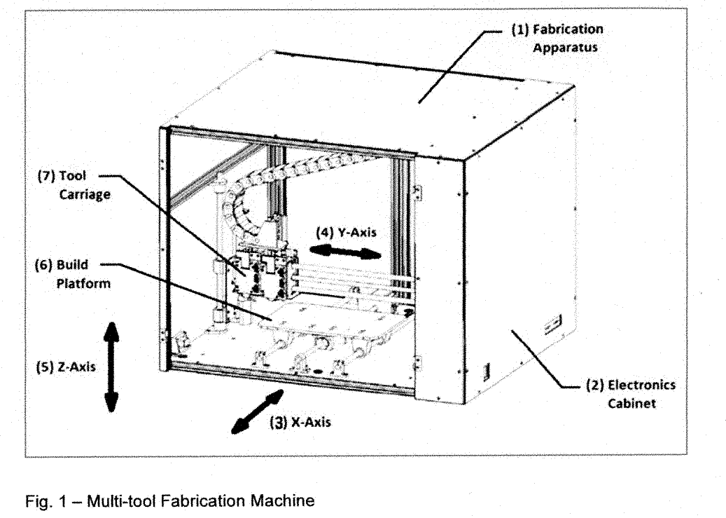

A fabrication machine 1 such as the one shown in FIG. 1 consisting of an electronics cabinet 2 containing power regulation components, a computer, and various electronic components to monitor and control devices on the machine. The computer moves the build platform 6 in the direction of the X-Axis 3 and independently moves the tool carriage 7 in the Y-Axis 4 and Z-Axis 5. For clarity, the tool carriage 7 shown in FIG. 1 is empty. There are no tools loaded in it. It can contain four separate tools in its four tool slots as installed by the user. Each tool slot can be raised or lowered independently by a linear stepper motor dedicated to that tool slot. This secondary Z motion drive allows other tools to move out of the way (up) when one tool is in position (down) and performing its function.

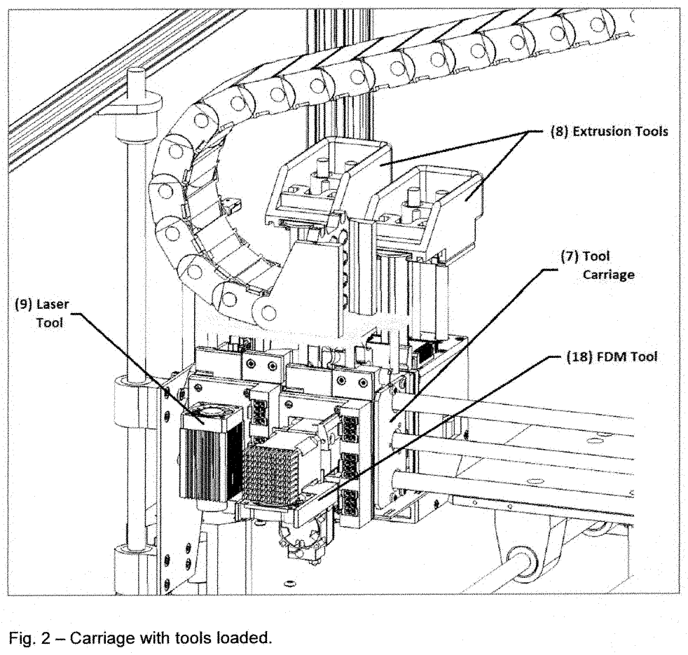

Tools are inserted by the user. They are mated to the tool carriage 7 with four guide pins. As the tool is pushed upon the guide pins electrical connectors 14 on the tool align with receiving electrical connectors on the tool carriage 7. When fulling inserted, each tool latches into place preventing it from being removed without actively releasing the latch. FIG. 2 shows the fabrication machine 1 loaded with two extrusion tools 8 one laser tool 9, and one FDM tool 18 for example. The machine can be loaded with any combination of tool located in any combination of tool slot.

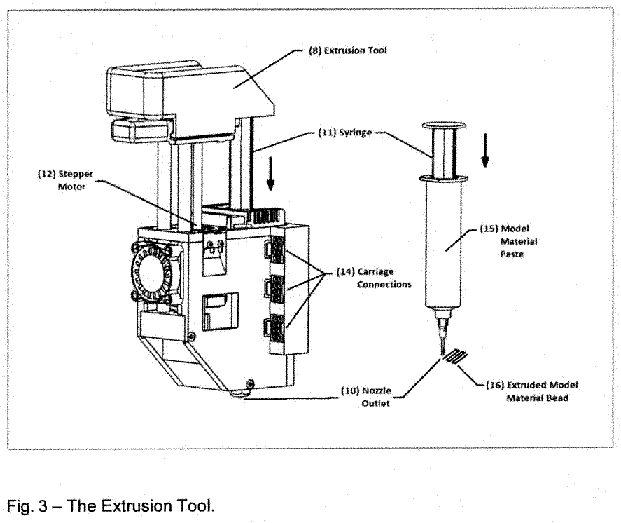

FIG. 3 shows what an extrusion tool 8 consists of. Model material paste 15 is contained within a syringe 11 that fits within the extrusion tool 8. A stepper motor 12 that is controlled by the same computer that controls the X,Y, and Z motion of the tool carriage 7 also controls depression of the syringe 11 plunger to synchronize model material paste 15 output through the nozzle outlet 10 relative to X, Y, and Z motion. The resulting extruded model material bead 16 can be turned on or off, and controlled in width and thickness as the rate of syringe 11 plunger depression is increased or reduced relative to the speed of the tool carriage 7 over the build platform 6. When the extrusion tool 8 is inserted into the fabrication machine 1, the carriage connections 14 of the extrusion tool 8 mate with receiving connectors on the tool carriage 7. This electrical connection provides power and control to the tool from the electronics contained within the electronics cabinet 2 as well as information regarding the function of the tool through the non-volatile memory carried on the tool. The extrusion tool 8 is an additive fabrication tool.

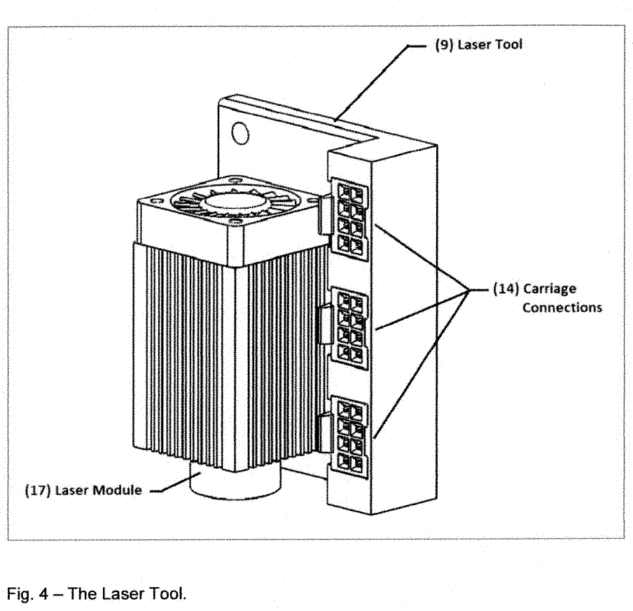

FIG. 4 shows what a laser tool 9 consists of. As with all other tools, the carriage connections 14 mate with receiving connectors on the tool carriage 7 to provide power and control to the tool as well as to identify the tool through its nonvolatile memory. The laser tool 9 contains a laser module 17 that generates a concentrated intense beam of light capable of heating whatever it is shining on. Depending on the target material, that beam of light can be used to melt material, vaporize material, burn material, or just cure material. The strength of the laser beam can be increased or reduced by the control electronics. As the laser beam is traced over the material it is shining on, the strength is modulated in synchronization with the X, Y, and Z position of the tool. The laser tool 9 is a subtractive fabrication tool.

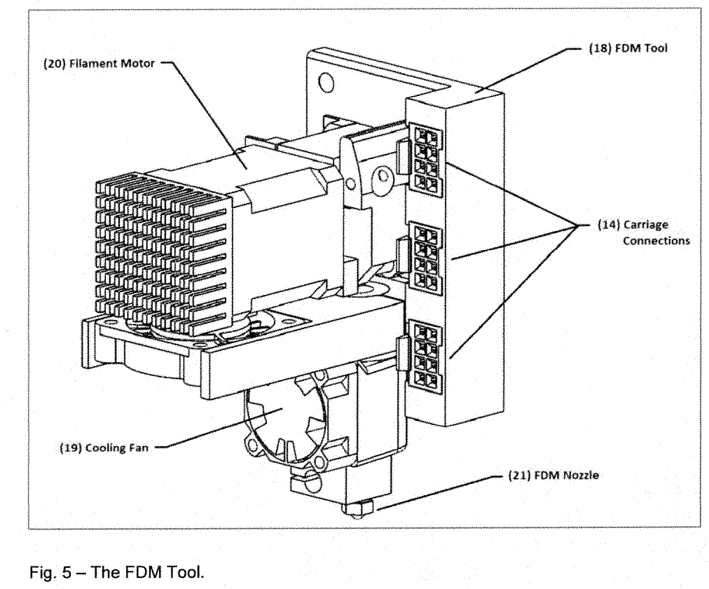

FIG. 5 shows what an FDM tool 18 consists of. As with all other tools, the carriage connections 14 mate with receiving connectors on the tool carriage 7 to provide power and control to the tool as well as to identify the tool through its nonvolatile memory. During operation, plastic filament is drawn into the top of the FDM tool 18 behind the cooling fan 19 by the filament motor 20. As the filament motor 20 pushes the filament into the FDM tool 18 it is melted before it is extruded out of the FDM nozzle 21. Once out of the FDM nozzle 21 the melted plastic cools and hardens to form a bead of hard plastic material. The filament motor 20 is controlled by the same computer that controls the X,Y, and Z motion of the tool carriage 7. The speed of the filament motor 20 is synchronized relative to X, Y, and Z motion allowing the resulting plastic bead to be thicker or wider as the filament motor 20 speed is increased or reduced relative to the speed of the tool carriage 7 over the build platform 6. The FDM tool 18 is an additive fabrication tool.

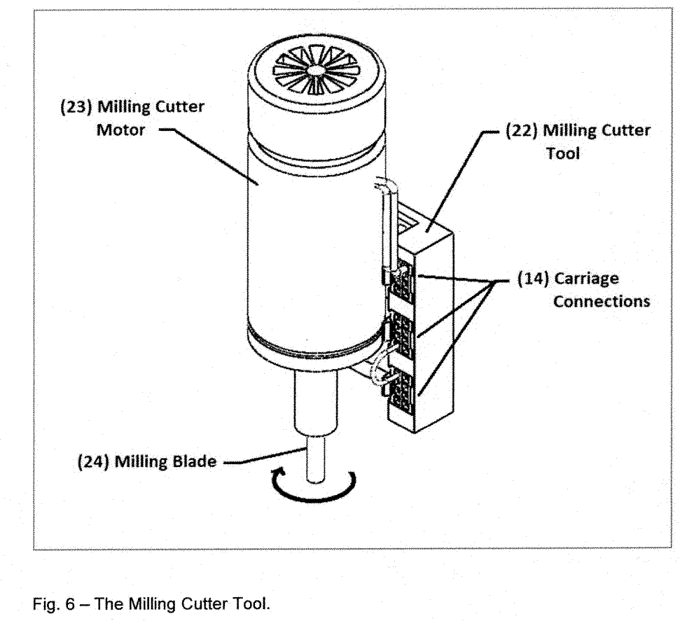

FIG. 6 shows what a milling cutter tool 22 consists of. As with all other tools, the carriage connections 14 mate with receiving connectors on the tool carriage 7 to provide power and control to the tool as well as to identify the tool through its nonvolatile memory. The milling blade 24 is spun by the milling cutter motor 23 which is actuated in both rotational speed and rotational direction by the electronics within the electronics cabinet 2. The milling cutter tool 22 is a subtractive fabrication tool.

### Apparatus Operation

The multi-tool fabrication machine operates on digital data the way a common 3D printer does. It accepts a 3D model of the desired component(s) in STL, AMF, GERBER, or G-CODE file format. 3D models can be generated from a variety of sources including computer aided design systems, scanners, or tomography data. Once the user transfers the input file(s) to the multi-tool fabrication machine via network or USB stick, they must select which tools and materials to use for the job. The tools and materials dictate how the machine can build the desired component requesting the user associate specific portions of the input file(s) to a specific tool and material. The user selects tools by simply installing them into the machine. The machine automatically recognizes the tool and its capabilities. Depending on which tools are installed, the system may also request a desired resolution and/or surface finish on specific faces of the input file because there may be multiple uses of certain tools within one build job.

The general build process is as follows:

1. The user creates an STL/AMF surface representation or G-CODE/GERBER tool path representation of their desired component.

2. The file is loaded into the Multi-tool Fabrication Machine via network or USB.

3. The user installs the tools they want used to build their component into the Multi-tool Fabrication Machine.

4. The user installs a build plate along with any existing component to be printed upon, or any raw material that will be subtracted from.

5. The user initiates a build job and the machine uses a distance sensor mounted to the underside of the tool carriage to scan the build platform to determine if it is empty or has an existing component or raw material on it.

6. If the build platform is empty, the machine uses the scan to establish the planarity of the build platform and adjusts the slicing plane accordingly.

7. If the table is not empty, a high resolution scan of the build platform is done and the user is prompted if the existing material on the build plate is to be added to, or is raw material to be subtracted from.

8. The machine then reads the tool types and capabilities and presents the user the viable options for the fabrication of their component. For additive tools, a material type is requested. For subtractive tools, further tool details are requested (like cutting blade diameter), as well as the function the user wishes to perform with that tool. The user then associates each tool with an input file.

9. Based on the shape of any existing component on the build platform, and the shape of the new components and the model material(s) selected, the machine makes a recommendation for support material.

10. The machine then slices each input file per the tool and material selected for that file. Note that the slice thicknesses for different tools do not have to be the same. For example, the filament fused deposition (FDM) tool may deposit plastic in layers that are 0.25 mm thick while an Extrusion tool may deposit silicone in layers that are 0.33 mm thick. Software keeps track of the height of each tool's deposition on all loaded model files to avoid any overlapping conflicts. Slices are then sequenced based on their thickness, the materials used, and the dictated additive and/or subtractive operations.

11. Step 10 is repeated until the entire height of the new component has been sliced and deposited (in the case of an additive build), or sliced and removed (in the case of a subtractive build).

1. A self-configuring computer-controlled fabrication apparatus that utilizes no fewer than four user changeable tools concurrently installed to fabricate a component from digital design data.

2. The apparatus in claim 1 in which at least one tool fabricates components additively and at least one tool subsequently modifies the material deposited by the additive tool.

3. The apparatus in claim 1 in which at least one tool fabricates components additively and at least one tool fabricates components via subtraction.

4. The apparatus in claim 1 in which at least two tools fabricate components additively through uniquely different additive processes.

5. The apparatus in claim 1 in which each tool shares the same type of physical and electrical connection between the tool and the tool carriage.

6. The apparatus in claim 5 in which any type of tool can be installed into any tool slot on the apparatus's tool carriage.

7. The apparatus in claim 1 in which each tool contains a non-volatile memory containing information about the identity, function, and performance of the tool.

8. The apparatus in claim 7 in which the apparatus automatically selects a build process based on the tools loaded in it.

9. A self-configuring computer-controlled fabrication apparatus that utilizes no fewer than four user changeable tools concurrently installed to additively fabricate a component from digital design data in layers of different thickness for each tool.
